(19) United States
(12) Patent Application Publication
(10) Pub. No.: US 2024/0170780 A1
(43) Pub. Date: May 23, 2024

(54) BATTERY PACK

(71) Applicant: AISAN KOGYO KABUSHIKI KAISHA, Obu-shi, Aichi (JP)

(72) Inventors: Kazuki TAGA, Nagoya-shi (JP); Noriak TERASAWA, Tokai-shi (JP)

(21) Appl. No.: 18/281,167

(22) PCT Filed: Jan. 11, 2022
(86) PCT No.: PCT/JP2022/000599

§ 371 Date: Sep. 8, 2023

(30) Foreign Application Priority Data
Mar. 22, 2021 (JP) 2021-0420217211

(51) Int. Cl. H01M 50/242; H01M 50/204; H01M 50/238; H01M 50/264; H01M 50/271

(52) U.S. Cl. CPC H01M 50/242; H01M 50/204; H01M 50/238; H01M 50/264; H01M 50/271; H01M 2220/20

(57) ABSTRACT

A battery pack may house battery cells. The battery pack may include a battery case in which the battery cells are arranged; and a lid member configured to close an opening in an upper portion of the battery case. The lid member may be fixed to a battery support member and is formed from an elastic material that reduces transmission of vibration of the battery support member to the battery case.

### TECHNICAL FIELD

This application claims priority to Japanese Patent Application No. 2021-047211, filed on Mar. 22, 2021, the entire contents of which are hereby incorporated by reference into the present application. The disclosure herein discloses a technique related to a battery pack that houses battery cells.

### BACKGROUND ART

Japanese Patent Application Publication No. 2018-538662 (hereafter referred to as Patent Literature 1) describes a technique related to a battery mounded on a vehicle and the like. In Patent Literature 1, battery cells are fixed inside a battery pack and the battery pack is mounted on the vehicle and the like.

### SUMMARY OF INVENTION

The battery pack of Patent Literature 1 is fixed to another member of the vehicle and the like while housing a plurality of battery cells. In the battery pack of Patent Literature 1, however, vibration caused by the other member tends to be transmitted to the battery pack, as a result of which the vibration caused by the other member is transmitted to the battery cells. It is necessary to suppress the transmission of the vibration of the other member to the battery cells in order to improve durability and safety of the battery (battery cells). The present disclosure provides a technique that realizes a battery pack that may suppress transmission of vibration caused by another member to battery cells.

A first technique disclosed herein is a battery pack that houses battery cells. This battery pack may comprise: a battery case in which the battery cells are arranged; and a lid member configured to close an opening in an upper portion of the battery case. Further, in this battery pack, the lid member may be fixed to a battery support member and be formed from an elastic material that reduces transmission of vibration of the battery support member to the battery case.

A second technique disclosed herein is the battery pack of the first technique, and the lid member may be formed such that, when the battery pack is fixed to the battery support member, a surface on which the lid member is fixed to a housing member is included in a same plane as a surface on which the lid member is fixed to the battery support member.

A third technique disclosed herein is the battery pack of the first or the second technique, and a pressing portion configured to press the battery cells may be provided on the lid member.

A fourth technique disclosed herein is the battery pack of the third technique, a bottom portion of the battery case may be formed from a material having higher rigidity than the lid member and an inner surface of the bottom portion may have a planer shape.

A fifth technique disclosed herein is the battery pack of one of the first to fourth techniques, and a reinforcement member reinforcing the bottom portion may be provided on an outer surface of the bottom portion of the battery case.

A sixth technique disclosed herein is the battery pack of one of the first to fifth techniques, and the battery case may be suspended by the lid member so that the outer surface of the bottom portion is not in contact with the battery support member.

A seventh technique disclosed herein is the battery pack of the sixth technique, and the outer surface of the bottom portion of the battery case may be in contact with a shock absorbing material arranged between the battery case and the battery support member.

An eighth technique disclosed herein is the battery pack of the sixth or seventh technique, and a part of the bottom portion of the battery case may face a restriction member arranged between the battery case and the battery support member and configured to suppress vertical displacement of the battery case.

### Effects of Invention

According to the first technique, vibration of apparatus (e.g., a vehicle such as manned or unmanned airplane, automobile) on which the battery pack is mounted is reduced by the lid member, by which it is possible to suppress the battery case from vibrating. By suppressing the vibration of the battery case, occurrence of abnormalities of the battery cells in the battery case can be suppressed.

According to the second technique, work efficiency in assembling the battery pack (fixing the lid member and the battery case) and fixing the battery pack to the battery support member (a support member provided on the apparatus on which the battery pack is mounted) is improved. Further, when the battery pack is fixed to the battery support member, a position of the battery pack with respect to a base of the battery support member can be determined.

According to the third technique, fixing the lid member to the battery case can suppress movement of the battery cells in the battery case. Suppressing the movement of the battery cells suppresses application of load on wires and the like connected to the battery cells, by which durability of the battery pack is improved. Further, expansion of the battery cells can also be suppressed by the pressing portion. According to the third technique, the movement of the battery cells in the battery case and the expansion of the battery cells can be suppressed only by fixing the lid member to the battery case (assembling the battery case).

According to the fourth technique, deformation of the battery cells can be suppressed while the vibration applied to the battery case due to the deformation of the lid member is suppressed. As a result, deterioration of the battery cells can be suppressed.

According to the fifth technique, strength of the bottom portion of the battery case is further increased, and the deformation of the battery cells can be further suppressed.

According to the sixth technique, it is possible to suppress the battery case from coming into contact with the battery support member to apply impact on the battery case. As a result, occurrence of abnormalities in the battery cells in the battery case can be suppressed.

According to the seventh technique, the vibration of the apparatus on which the battery pack is mounted can be reduced by both the lid member and the shock absorbing material. Vibration applied to the battery case can be further suppressed, and occurrence of abnormalities in the battery cells can be further suppressed.

According to the eighth technique, a displacement amount of the battery pack can be limited even when the apparatus on which the battery pack is mounted vibrates intensely and the lid member is greatly deformed. As a result, it is possible to suppress the wiring and the like connected to the battery pack from getting damaged.

### BRIEF DESCRIPTION OF DRAWINGS

FIG. 1 illustrates a cross-sectional view of a battery pack support structure of a first embodiment; and

FIG. 2 illustrates a cross-sectional view of a battery pack support structure of a second embodiment.

### DETAILED DESCRIPTION

### First Embodiment

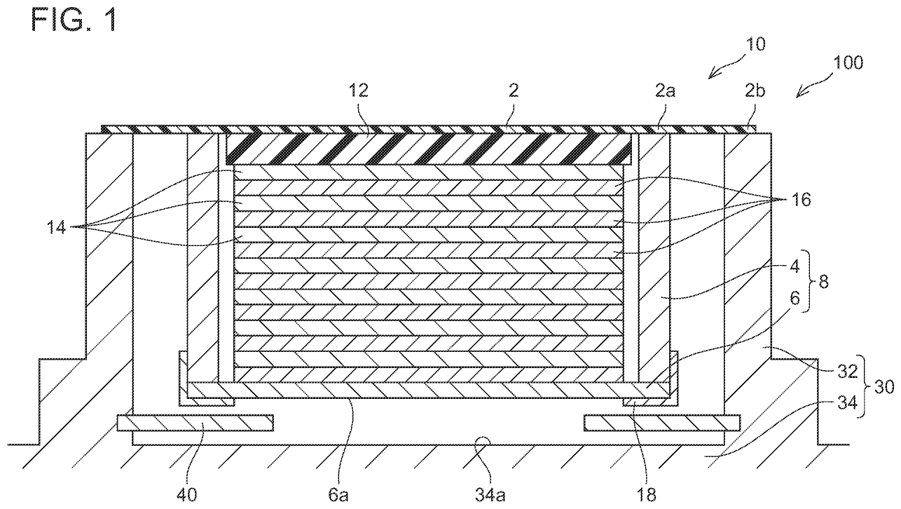

Referring to FIG. 1, a battery pack support structure 100 will be described. FIG. 1 shows a battery pack 10 in the state of being fixed to a battery support member 30 provided in a vehicle such as an automobile, manned or unmanned aircraft, or the like. The battery support member 30 includes a base 34, which is fixed to a battery mounting portion (not shown) of the vehicle, and a pillar 32, which extends upward from the base 34 in a direction of gravity (vertical direction).

The battery pack 10 includes a battery case 8 and a lid member 2. The battery case 8 is box-shaped, has an opening on one side (top portion), and includes a bottom portion 6 and a side wall 4. The bottom portion 6 and side wall 4 are formed of a thin sheet of metal. The inner surface of the bottom portion 6 (the inner surface of the battery case 8) has a planar shape. In other words, no unevenness is formed on the inner surface of the bottom portion 6. A reinforcement member 18 is fixed to the outer surface of the battery case 8. The reinforcement member 18 is fixed to a part of the bottom portion 6 and a part of the side wall 4. The battery case 8, especially the bottom portion 6, is reinforced by the reinforcement member 18. As a result, the strength of the bottom portion 6 of the battery case 8 is further increased and the deformation of the battery cells 16 can further be suppressed.

A plurality of battery cells 16 and a plurality of heatsinks 14 are arranged within the battery case 8. The battery cells 16 and the heatsinks 14 are stacked alternately in the vertical direction (the direction connecting the bottom portion 6 and an opening in an upper portion of the battery case 8). Although not shown in the figure, each battery cell 16 includes electrode tabs protruding from its exterior. In the battery pack 10, the electrode tabs of each of the battery cells 16 are connected to each other so that all the battery cells 16 are connected in series. How the battery cells 16 are connected is well known, so the description is omitted.

The lid member 2 seals the opening in the upper portion of the battery case 8. The lid member 2 is formed of a thin sheet of resin. The lid member 2 is an elastic material and has a lower modulus of elasticity than the battery case 8. Therefore, the lid member 2 can deform with less force than the battery case 8. In other words, the lid member 2 can deform even by a force that does not deform the battery case 8. The bottom portion 6 of the battery case 8 is formed of a material having higher rigidity than the lid member 2. Therefore, even when the lid member 2 deforms, the deformation of the battery cells 16 is suppressed, and thus the deterioration of the battery cells 16 can be suppressed. A first fixing portion 2a and a second fixing portion 2b are provided on the lid member 2. The first fixing portion 2a is fixed to the battery case 8, and the second fixing portion 2b is fixed to the battery support member 30 (pillar 32). Although not illustrated, the first fixing portion 2a and the battery case 8, and the second fixing portion 2b and the battery support member 30 are fixed by bolts. Since the lid member 2 is plate-shaped, when the battery pack 10 is fixed to the battery support member 30, a surface on which the lid member 2 (the first fixing portion 2a) is fixed to the battery case 8 (the side wall 4) is included in the same plane as a surface on which the lid member 2 (the second fixing portion 2b) is fixed to the battery support member 30 (the pillar 32). Therefore, when the battery pack 10 is fixed to the battery support member 30 (pillar 32), the position (height from the base 34) of the battery pack 10 relative to the base 34 of the battery support member 30 is determined.

In the battery pack support structure 100, when the battery pack 10 is fixed to the battery support member 30, the battery pack 10 is suspended by the lid member 2 so that the outer surface 6a of the bottom portion 6 of the battery case 8 is not in contact with a surface 34a of the base 34 of the battery support member 30. As described above, the lid member 2 is an elastic material and can deform by relatively weak force. Therefore, vibrations of the vehicle on which the battery pack 10 is mounted (more precisely, vibrations of the battery support member 30) can be attenuated by the lid member 2 and the transmission of the vibration to the battery case 8 can be reduced. By suppressing the vibration of the battery case 8, occurrence of abnormalities in the battery cells 16 in the battery case 8 can be suppressed.

A resin-made pressing portion 12 is provided on the lid member 2. The pressing portion 12 is plate-shaped and is provided at a part (center) of the lid member 2. When the lid member 2 is fixed to the battery case 8, the pressing portion 12 is positioned inside the battery case 8. When the lid member 2 is fixed to the battery case 8, the pressing portion 12 contacts the battery cells 16 and applies force to the battery cells 16. In other words, when the lid member 2 is fixed to the battery case 8, the battery cell 16s are held between the pressing portion 12 and the bottom portion 6 of the battery case 8, and compression force is applied. The pressing portion 12 can suppress the battery cells 16 from moving or expanding within the battery case 8. By suppressing the movement of the battery cells 16, application of the load on the wiring and the like connected to the battery cells 16 is suppressed and the durability of the battery pack 10 is improved.

A restriction member 40 is arranged between the bottom portion 6 of the battery case 8 and the base 34 of the battery support member 30. More precisely, the restriction member 40 is fixed to the pillar 32 of the battery support member 30 and protrudes toward the space between the base 34 and the bottom portion 6 of the battery case 8. As a result, a portion of the bottom portion 6 of the battery case 8 faces the restriction member 40. The restriction member 40 restricts the vertical displacement of the battery case 8 (battery pack 10) so that it does not exceed a predetermined amount. In other words, even when the battery support member 30 vibrates greatly and the lid member 2 deforms greatly, the vertical displacement of the battery case 8 can be limited to the predetermined amount or less. As a result, damage to the wiring and the like connected to the battery pack 10 can be suppressed.

### Second Embodiment

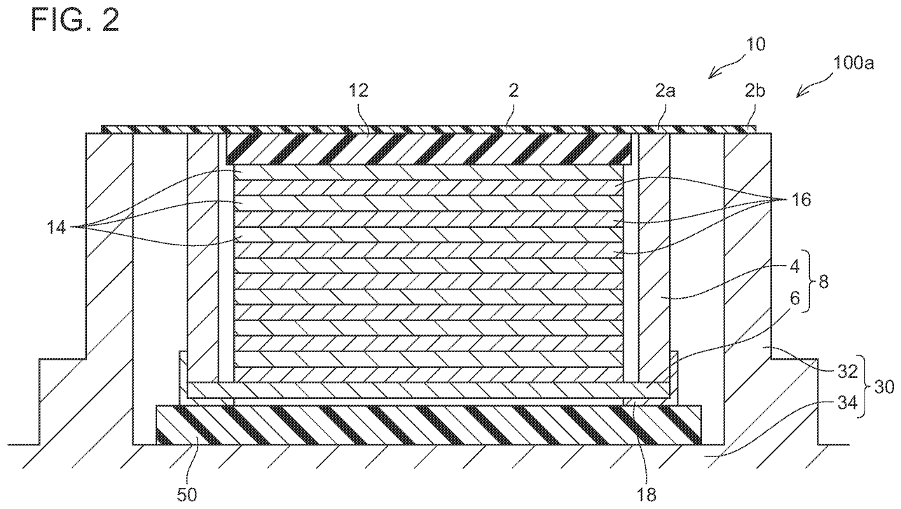

Referring to FIG. 2, a battery pack support structure 100a will be described. The battery pack support structure 100a is a variant of the battery pack support structure 100 and differs therefrom in that a shock absorbing material 50 is provided between the bottom portion 6 of the battery case 8 and the base 34, instead of the restriction member 40 provided on the battery pack support structure 100. With regard to the battery pack support structure 100a, a description of structures identical to those of the battery pack support structure 100 will be omitted by giving the same reference numbers as those given to the battery pack support structure 100. The structure of the battery pack 10 is the same in both of the battery pack support structures 100 and 100a.

The bottom portion 6 of the battery case 8 (more precisely, the reinforcement member 18 reinforcing the bottom portion 6) is in contact with the shock absorbing material 50. Therefore, the vibration transmitted from the battery support member 30 to the battery case 8 is reduced by both the lid member 2 and the shock absorbing material 50. As a result, the transmission of the vibration of the battery support member 30 to the battery case 8 can be further reduced. The shock absorbing material 50 can also limit the vertical displacement of the battery case 8 to a predetermined amount or less. As a result, the occurrence of abnormalities in the battery cells 16 can be further suppressed.

### Other Embodiments

In the above embodiments, an aspect in which the restriction member is provided between the bottom portion of the battery case and the base of the battery support member and an aspect in which the shock absorbing material is provided between the bottom portion of the battery case and the base of the battery support member were described. However, the restriction member and the shock absorbing material are not essential and can be omitted, if necessary. Alternatively, both the restriction member and the shock absorbing material may be provided between the bottom portion of the battery case and the base of the battery support member, if necessary.

The lid member only needs to be fixed to the battery support member and be formed from an elastic material that reduces transmission of the vibration of the battery support member to the battery case, and when the battery pack is fixed to the battery support member, the surface on which the lid member is fixed to the battery case need not necessarily be included in the same plane as the surface on which the lid member is fixed to the battery support member. The pressing portion does not have to be provided on the lid member. For example, a pressing member which is separate from both the lid member and the battery cell may be arranged therebetween, and the pressing member may press the battery cells when the lid member is fixed to the battery case. The reinforcement member may be omitted by increasing a thickness of the bottom portion of the battery case.

Specific examples of the present invention have been described in detail, however, these are mere exemplary indications and thus do not limit the scope of the claims. The art described in the claims includes modifications and variations of the specific examples presented above. Technical features described in the description and the drawings may technically be useful alone or in various combinations, and are not limited to the combinations as originally claimed. Further, the art described in the description and the drawings may concurrently achieve a plurality of aims, and technical significance thereof resides in achieving any one of such aims.

1. A battery pack that houses battery cells, the battery pack comprising:
a battery case in which the battery cells are arranged; and
a lid member configured to close an opening in an upper portion of the battery case, wherein
the lid member is fixed to a battery support member and is formed from an elastic material that reduces transmission of vibration of the battery support member to the battery case.

2. The battery pack according to claim 1, wherein
the lid member is formed such that, when the battery pack is fixed to the battery support member, a surface on which the lid member is fixed to the battery case is included in a same plane as a surface on which the lid member is fixed to the battery support member.

3. The battery pack according to claim 2, wherein
a pressing portion configured to press the battery cells is provided on the lid member.

4. The battery pack according to claim 3, wherein
a bottom portion of the battery case is formed from a material having higher rigidity than the lid member and an inner surface of the bottom portion has a planer shape.

5. The battery pack according to claim 4, wherein
a reinforcement member reinforcing the bottom portion is provided on an outer surface of the bottom portion of the battery case.

6. The battery pack according to claim 5, wherein
the battery case is suspended by the lid member so that the outer surface of the bottom portion is not in contact with the battery support member.

7. The battery pack according to claim 6, wherein
the outer surface of the bottom portion of the battery case is in contact with a shock absorbing material arranged between the battery case and the battery support member.

8. The battery pack according to claim 7, wherein
a part of the bottom portion of the battery case faces a restriction member arranged between the battery case and the battery support member and configured to suppress vertical displacement of the battery case.

9. The battery pack according to claim 1, wherein
a pressing portion configured to press the battery cells is provided on the lid member.

10. The battery pack according to claim 1, wherein
a reinforcement member reinforcing the bottom portion is provided on an outer surface of the bottom portion of the battery case.

11. The battery pack according to claim 1, wherein
the battery case is suspended by the lid member so that the outer surface of the bottom portion is not in contact with the battery support member.

12. The battery pack according to claim 11, wherein
a part of the bottom portion of the battery case faces a restriction member arranged between the battery case and the battery support member and configured to suppress vertical displacement of the battery case.

13. The battery pack according to claim 11, wherein
the outer surface of the bottom portion of the battery case is in contact with a shock absorbing material arranged between the battery case and the battery support member.
